(19) United States
(12) Patent Application Publication
(10) Pub. No.: US 2022/0108858 A1
(43) Pub. Date: Apr. 7, 2022

(54) Relay Device and Control Method of Relay Device

(71) Applicant: Marelli Corporation, Saitama-shi, Saitama (JP)

(72) Inventors: Kouichirou Horikoshi, Saitama-shi, Saitama (JP); Junya Tanaka, Saitama-shi, Saitama (JP)

(21) Appl. No.: 17/310,364

(22) PCT Filed: Jan. 23, 2020
(86) PCT No.: PCT/JP2020/002366

§ 371 Date: Jul. 29, 2021

(30) Foreign Application Priority Data
Jan. 30, 2019 (JP) 2019-014797

(51) Int. Cl. H01H 47/22; H01H 50/58

(52) U.S. Cl. CPC H01H 47/22; H01H 50/58

(57) ABSTRACT

A relay device includes a coil portion, a fixed contact, a moving contact and a spring. The coil portion generates an electromagnetic force that moves the moving contact toward the fixed contact through energization. The spring applies an elastic force in a direction in which the moving contact separates from the fixed contact. The drive circuit controls an electromagnetic force of the coil portion to be a first electromagnetic force, continuously for a first time, when switching the fixed contact and the moving contact in a non-contact state to a contact state, and after that, to be increased in sages on the basis of a tolerance range of the spring constant of the spring.

### CROSS-REFERENCE TO RELATED APPLICATION

This application claims priority to and benefit of Japanese Patent Application No. 2019-014797 filed on Jan. 30, 2019, the entire contents of which are incorporated herein by reference.

### TECHNICAL FIELD

The present invention relates to a relay device and a control method of the relay device.

### BACKGROUND

A relay device including a moving contact, a fixed contact and a coil portion has been known. In such a relay device, the position of the moving contact with respect to the fixed contact is controlled by controlling the current flowing through the coil portion, and the fixed contact and the moving contact are switched between a contact state and a non-contact state.

For example, in the relay device disclosed in Patent Literature 1 (PTL 1), the moving contact is decelerated by controlling the current flowing through the coil portion when switching the moving contact and the fixed contact in the non-contact state to the contact state. In the relay device disclosed in PTL 1, when the moving contact comes in contact with the fixed contact, the impact generated by the moving contact hitting the fixed contact is weakened by decelerating the moving contact. In the relay device disclosed in PTL 1, by reducing the impact generated when the moving contact hits the fixed contact, the moving contact is prevented from bouncing and vibrating at the fixed contact.

### CITATION LIST

### Patent Literature

PTL 1: JP2018107046 (A)

### SUMMARY

In the above-described relay device, an elastic force of a spring is applied to the moving contact. The spring constant of the spring may vary. When the spring constant varies, even if a current flowing through the coil portion is controlled, the moving contact to which an elastic force of a spring having a small spring constant is applied may not be sufficiently decelerated. In this case, the impact caused by the moving contact hitting the fixed contact may become stronger. Noise may be generated when the impact generated by the moving contact hitting the fixed contact increases.

It is therefore an object of the present invention to provide a relay device configured to prevent noise generation when a moving contact and a fixed contact in a non-contact state is switched to a contact state, and a control method of the relay device.

A relay device according o a first aspect to solve the above-described problem includes:

a fixed contact;
a moving contact;
a spring configured to apply an elastic force in a separating direction in which the moving contact separates from the fixed contact;
a coil portion configured to generate an electromagnetic force that moves the moving contact toward the fixed contact through energization; and
a drive circuit configured to control the electromagnetic force by controlling coil current flowing through the coil portion, wherein,
the drive circuit controls the electromagnetic force to be a first electromagnetic force continuously for a first time (a first period of time) when switching the fixed contact and the moving contact in a non-contact state to a contact state, after that, controls the electromagnetic force to be increased from the first electromagnetic force in stages, and in a final stage in which the electromagnetic force is controlled to be increased from the first electromagnetic force in stages, controls the electromagnetic force to be a predetermined electromagnetic force that is greater than the first electromagnetic force,
the first electromagnetic force being equal to or greater than an elastic force applied by the spring having a spring constant of a lower limit value in a tolerance range when the moving contact is in a contact position in contact with the fixed contact, and being smaller than the elastic force applied by the spring having a spring constant of a median value in the tolerance range when the moving contact is present at the contact position, and
the predetermined electromagnetic force being equal to or greater than the elastic force applied by the spring having a spring constant of an upper limit value in the tolerance range when the moving contact is present at the contact position.

A control method of a relay device according to a second aspect to solve the above-described problem is a control method of a relay device, the relay device including:

a fixed contact;
a moving contact;
a spring configured to apply an elastic force in a separating direction in which the moving contact separates from the fixed contact;
a coil portion configured to generate an electromagnetic force that moves the moving contact toward the fixed contact through energization; and
a drive circuit configured to control the electromagnetic force by controlling coil current flowing through the coil portion,
the method including the steps of:
controlling, by the drive circuit, the electromagnetic force to be a first electromagnetic force continuously for a first time when the fixed contact and the moving contact in a non-contact state are switched to a contact state; controlling, by the drive circuit, the electromagnetic force to be increased from the first electromagnetic force in stages; and.
controlling, by the drive circuit, the electromagnetic force to be a predetermined electromagnetic force that is greater than the first electromagnetic force in a final stage in which the electromagnetic force is controlled to be increased in stages from the first electromagnetic force, wherein:
the first electromagnetic force is equal to or greater than an elastic force applied by the spring having a spring constant of a lower limit value in a tolerance range when the moving contact is present at a contact position in contact with the fixed contact, and is equal to or smaller than the elastic force applied by the spring having a spring constant of a median value in the tolerance range when the moving contact is present at the contact position; and
the predetermined electromagnetic force is equal to or greater than the elastic force applied by the spring having a spring constant of an upper limit value in the tolerance range when the moving contact is present at the contact position.

In the relay device according to the first aspect, noise generation is prevented when the moving contact and the fixed contact in a non-contact state is switched to a contact state.

In the control method of the relay device according to the second aspect, noise generation is prevented when the moving contact and the fixed contact in a non-contact state is switched to a contact state.

### BRIEF DESCRIPTION OF THE DRAWINGS

In the accompanying drawings:

FIG. 1 is a block diagram illustrating a configuration example of a relay device according to an embodiment;

FIG. 2 is a timing chart illustrating operation of the relay device illustrated in FIG. 1;

FIG. 3 is a timing chart illustrating speed and displacement of the moving contact illustrated in FIG. 1; and

FIG. 4 is a flowchart illustrating operation of the relay device illustrated in FIG. 1.

### DETAILED DESCRIPTION

An embodiment according to the present invention will be described below with reference to the drawings.

### Configuration Example of Relay Device

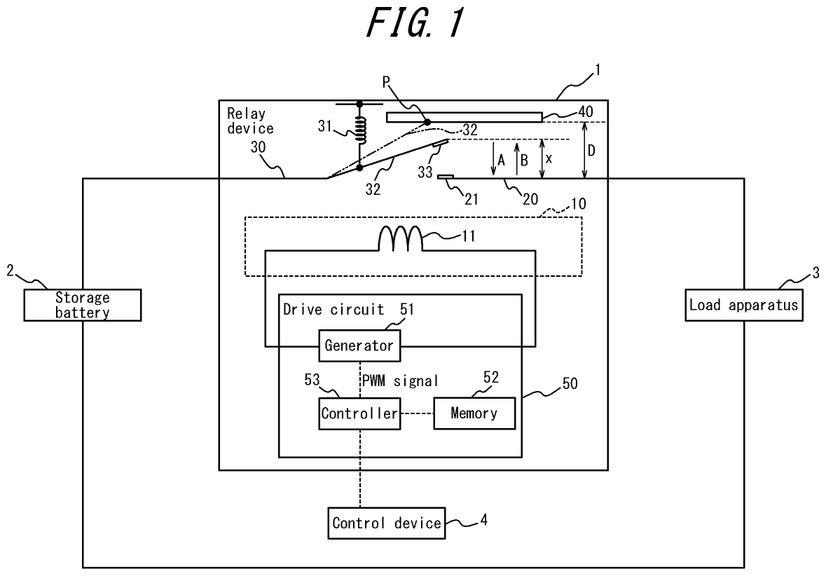

FIG. 1 is a block diagram illustrating a configuration example of a relay device 1 according to an embodiment. In FIG. 1, the solid lines connecting each functional block indicate flow of power. Further, in FIG. 1, the dashed lines connecting each functional block indicate flow of control or communication. The relay device 1, a storage battery 2, a load apparatus 3, and a control device 4 may be incorporated into one device (for example, a vehicle).

The relay device 1 is disposed between the storage battery 2 and the load apparatus 3. However, the relay device 1 may be disposed between any devices. The relay device 1 electrically connects or disconnects the storage battery 2 and the load apparatus 3 on the basis of control of the control device 4.

The storage battery 2 can supply charged power to the load apparatus 3 via the relay device 1. The load apparatus 3 consumes the power supplied from the storage battery 2 via the relay device 1.

The control device 4 is configured by including a microcomputer. The control device 4 outputs an on signal and an off signal to the relay device 1. The on signal is a signal that electrically connects the devices connected to the relay device 1 (the storage battery 2 and the load apparatus 3) to the relay device 1. The off signal is a signal that electrically disconnects the devices connected to the relay device 1 (the storage battery 2 and the load apparatus 3).

The relay device 1 includes a coil portion 10, a terminal board 20, a fixed contact 21, a terminal board 30, a spring 31, a moving piece 32, a moving contact 33, a stopper 40 and a drive circuit 50. The fixed contact 21 and the moving contact 33 are also collectively referred to as a “contact portion.

When energized, the coil portion 10 generates an electromagnetic force that moves the moving contact 33 toward the fixed contact 21. For example, the coil portion 10 generates an electromagnetic force that moves the moving contact 33 in the approaching direction A. The approaching direction A is a direction in which the moving contact 33 approaches the fixed contact 21.

The coil portion 10 is configured by including a coil 11. The coil portion 10 may include a bobbin, a stator, a yoke, and the like, in addition to the coil 11. The bobbin may be made of a resin material. The stator and the yoke may be made of a magnetic material.

The coil 11 may be a lead wire. The coil 11 may be wound onto a bobbin. A stator may be inserted into the coil 11. Both ends of the coil 11 may be connected to the drive circuit 50. Current is applied to the coil 11 by the drive circuit 50. When the coil 11 is energized, a magnetic path is formed through the stator and the yoke, and the like. When the magnetic path is formed, an electromagnetic force that moves the moving contact 33 in the approaching direction A is generated.

The terminal board 20 may be made of a conductive material. One end of the terminal board 20 is connected to the load apparatus 3. The other end of the terminal board 20 is provided with the fixed contact 21.

The fixed contact 21 may be made of a conductive material. The fixed contact 21 may be formed integrally with the terminal board 20. The fixed contact 21 is provided at a position facing the moving contact 33.

The terminal board 30 may be made of a conductive material. One end of the terminal board 30 is connected to the storage battery 2. The other end of the terminal board 30 is connected to the moving piece 32.

The spring 31 may be a coil spring. However, the spring 31 is not limited to a coil spring. The spring 31 may be a leaf spring, for example.

One end of the spring 31 is connected to the moving piece 32. The other end of the spring 31 is connected to a housing, and the like, of the relay device 1. The spring 31 applies an elastic force to the moving contact 33 in the separating direction B. The separating direction B is the direction in which the moving contact 33 separates from the fixed contact 21.

The magnitude of the elastic force of the spring 31 may depend on the magnitude of the spring constant of the spring 31, and the like. For example, the elastic force F1 is expressed by the following equation (1).

F1=k×(C−x) Equation (1)

In Equation (1), the spring constant k is a spring constant of the spring 31. The displacement x is a displacement of the moving contact 33 from the fixed contact 21. The constant C is an element determined based on the length (natural length), etc. of the spring 31 when no load is applied to the spring 31. It is to be noted that the constant C is longer than the distance D. The distance D is a distance from the fixed contact 21 to the stopper 40.

The elastic force of the spring 31 may increase as the spring constant of the spring 31 increases. The elastic force of the spring 31 may decrease as the spring constant of the spring 31 decreases. In this embodiment, the spring constant of the spring 31 has a value in the tolerance range.

Hereinafter, the spring 31 having a spring constant of a lower limit value in the tolerance range is also described as “spring 31L.” Further, the spring 31 having a predetermined spring constant value excluding the upper limit value and the lower limit value in the tolerance range is also described as “spring 31M.” It is to be noted that the predetermined value may be a median value in the tolerance range, although not limited thereto. Further, the spring 31 having a spring constant of the upper limit value in the tolerance range is also described as “spring 31U.”

The moving piece 32 may be made of a conductive material. The moving piece 32 is movable with respect to the terminal board 30. One end of the moving piece 32 is connected to the terminal board 30. The other end of the moving piece 32 is provided with the moving contact 33.

The moving contact 33 may be made of a conductive material. The moving contact 33 may be formed integrally with the moving piece 32. The moving contact 33 and the fixed contact 21 are in contact or non-contact state.

For example, the moving contact 33 moves in the approaching direction A (that is, the direction in which the moving contact 33 approaches the fixed contact 21) when the electromagnetic force generated by the coil portion 10 is greater than the elastic force of the spring 31. The moving contact 33 moves in the approaching direction A and comes in contact with the fixed contact 21. The position where the moving contact 33 comes in contact with the fixed contact 21 is referred to as a “contact position. When the moving contact 33 and the fixed contact 21 are in the contact state, the storage battery 2 and the load apparatus 3 are electrically connected.

For example, the moving contact 33 moves in the separating direction B (that is, the direction in which the moving contact 33 separates from the fixed contact 21) when the electromagnetic force generated by the coil portion 10 is smaller than the elastic force of the spring 31. The moving contact 33 will be in the non-contact state with the fixed contact 21 by moving in the separating direction B. When the moving contact 33 and the fixed contact 21 are in the non-contact state, the storage battery 2 and the load apparatus 3 are electrically disconnected. It is to be noted that the moving contact 33 may abut the stopper 40 by continuing to move in the separating direction B. In other words, the movement of the moving contact 33 is regulated by the stopper 40 at the fully open position P.

Hereinafter, the moving contact 33 to which the elastic force of the spring 31L is applied is also described as “moving contact 33L.” Further, the moving contact 33 to which the elastic force of the spring 31M is applied is also described as “moving contact 33M.” Then, the moving contact 33 to which the elastic force of the spring 31U is applied is also described as “moving contact 33U.”

The stopper 40 may be made of a metal member, although the material of the stopper is not particularly limited. The stopper 40 regulates the movement of the moving contact 33 in the separating direction B. The moving contact 33 may abut the stopper 40 when the moving contact 33 and the fixed contact 21 are in a non-contact state. The stopper 40 defines the fully open position P of the moving contact 33 with respect to the fixed contact 21 by abutting the moving contact 33. It is to be noted that, when the relay device 1 has no stopper 40, for example, the fully open position P of the moving contact 33 with respect to the fixed contact 21 may be defined by the other members.

The drive circuit 50 switches the coil portion 10 between the energized state and the non-energized state on the basis of the control of the control device 4. The drive circuit 50 includes a generator 51, a memory 52 and a controller 53.

The generator 51 is electrically connected to the coil 11 of the coil portion 10. The generator 51 includes a switching element, and the like. The generator 51 generates a coil current on the basis of control of the controller 53. The coil current is a current that flows through the coil portion 10, that is, the current that flows through the coil 11. In this embodiment, the generator 51 generates a coil current on the basis of the Pulse Width Modulation (PWM) control. In this embodiment, a PWM signal from the controller 53 is input to a switching element of the generator 51. The switching element of the generator 51 switches between on and off according to the duty ratio of the PWM signal. The switching element of the generator 51 switches according to the duty ratio of the PWM signal, and as a result a coil current according to the duty ratio of the PWM signal is generated.

Hereinafter, the “PWM signal cycle” is assumed to be the sum of a period during which the switching element of the generator 51 is turned on and a period during which the switching element of the generator 51 is turned off. Further, the “PWM duty ratio” is a value obtained by dividing a period during which the switching element of the generator 51 is turned on by a PWM signal cycle. In this case, the larger the duty ratio of the PWM signal, the longer a period during which the switching element of the generator 51 is turned on, and as a result a coil current increases. That is, as the duty ratio of the PWM signal increases, the coil current increases, and the electromagnetic force of the coil portion 10 increases. Further, the smaller the duty ratio of the PWM signal, the shorter the period during which the switching element of the generator 51 is turned off, and thus the coil current decreases. That is, the smaller the duty ratio of the PWM signal, the lower the coil current, and the electromagnetic force of the coil portion 10 decreases.

The memory 52 is connected to the controller 53. The memory 52 stores the information acquired from the controller 53. The memory 52 may serve as a working memory of the controller 53. The memory 52 may store a program executed by the controller 53. The memory 52 may be a semiconductor memory. The memory 52 is not limited to a semiconductor memory, and may be a magnetic storage, or other storage media. The memory 52 may be contained in the controller 53 as a part of the controller 53.

The controller 53 controls each component of the relay device 1. The controller 53 may be a processor such as a Central Processing Unit (CPU) configured to execute a program that defines a control procedure. The controller 53 reads a program stored in the memory 52 and executes various programs.

The controller 53 may acquire an off signal from the control device 4. When acquiring an off signal, the controller 53 switches the fixed contact 21 and the moving contact 33 in the contact state to the non-contact state. At the time of this switching, the controller 53 reduces the coil current by reducing the duty ratio of PWM signal to be output to the generator 51. The controller 53 reduces the coil current such that the electromagnetic force generated by the coil portion 10 will be smaller than the elastic force of the spring 31. When the electromagnetic force of the coil portion 10 is reduced to be smaller than the elastic force of the spring 31, the moving contact 33 moves in the separating direction B. When the moving contact 33 moves in the separating direction B, the fixed contact 21 is in non-contact with the moving contact 33. The moving contact 33 reaches the fully open position P by moving continuously in the separating direction B. When the moving contact 33 reaches the fully open position P, the controller 53 keeps the duty ratio of the PWN signal to 0%. The controller 53 keeps the switching element of the generator 51 in an off state by keeping the duty ratio of the PWN signal to 0%. The controller 53 keeps the fixed contact 21 and the moving contact 33 in a non-contact state by keeping the switching element of the generator 51 in an off state.

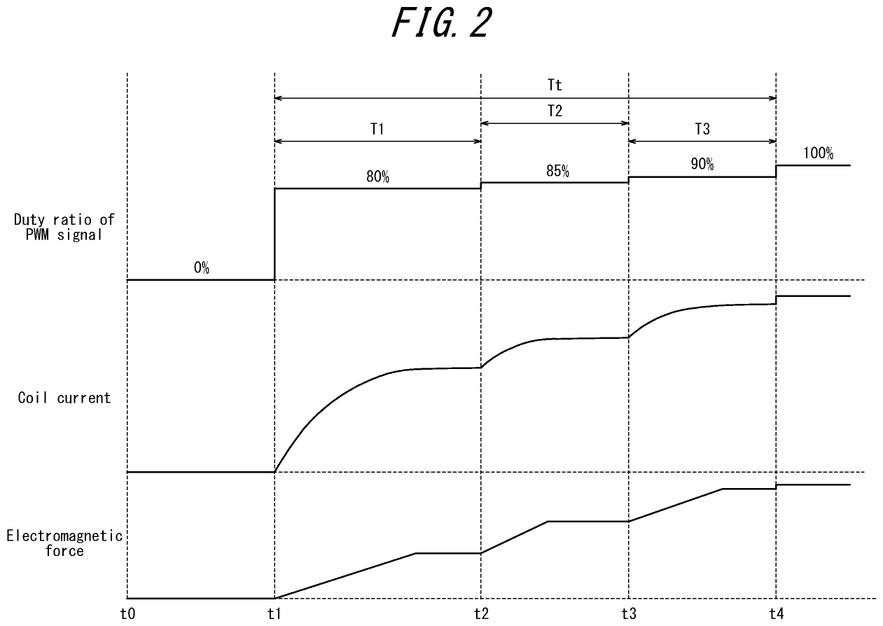

FIG. 2 is a timing chart illustrating operation of the relay device 1 illustrated in FIG. 1. At the time t0 illustrated in FIG. 2, the fixed contact 21 and the moving contact 33 are in the non-contact state. At the time t0 illustrated in FIG. 2, the controller 53 keeps the switching element of the generator 51 in the off state by keeping the duty ratio of the PWM signal to 0%.

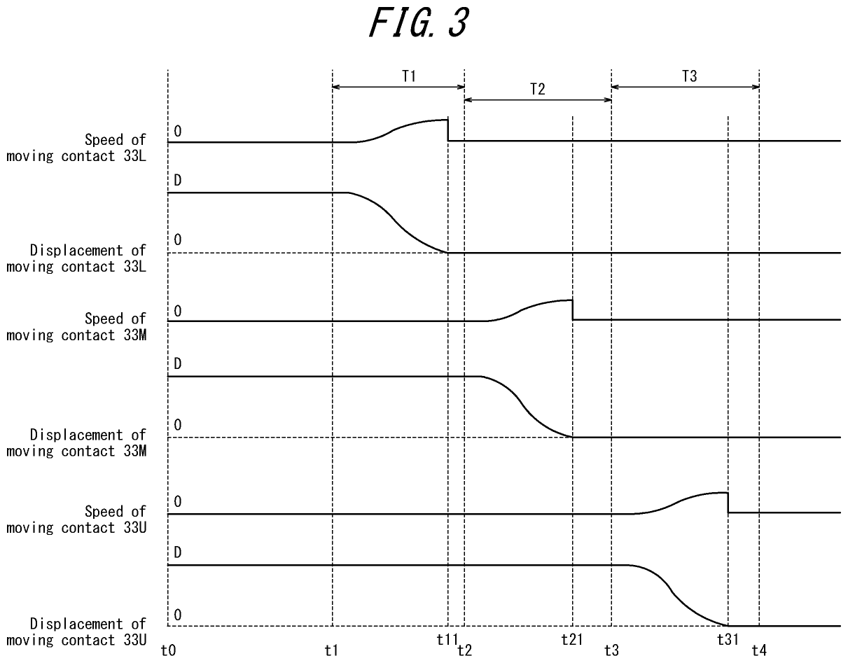

FIG. 3 is a timing chart illustrating the speed and the displacement of the moving contact 33. FIG. 3 illustrates the speed and the displacement of the moving contact 33L to which the elastic force of the spring 31L is applied, as an example of the moving contact 33 that is easy to move in the approaching direction A (difficult to move in the separating direction B) illustrated in FIG. 1. Further, FIG. 3 illustrates the speed and the displacement of the moving contact 33U to which the elastic force of the spring 31U is applied, as an example of the moving contact 33 that is easy to move in the separating direction B (difficult to move in the approaching direction A) illustrated in FIG. 1. Further, FIG. 3 illustrates the speed and the displacement of the moving contact 33M to which the elastic force of the spring 31M is applied, as a reference. The displacement of the moving contacts 33 illustrated in FIG. 3 is the displacement x from the fixed contact 21 illustrated in FIG. 1. At the time t0 illustrated in FIG. 3, all of the moving contacts 33L, 33M and 33U are present at the fully open position P. Thus, at the time t0 illustrated in FIG. 3, the displacements of all of the moving contacts 33L, 33M, and 33U are D. Further, when the moving contact 33 is present at the fully open position P, the movement of the moving contact 33 is prevented by the stopper 40. Thus, at the time t0 illustrated in FIG. 3, the speeds of all of the moving contacts 33L, 33M and 33U are 0.

The controller 53 may acquire an off signal from the control device 4. When acquiring an off signal, the controller 53 switches the fixed contact 21 and the moving contact 33 in the non-contact state to the contact state. At the time of this switching, the controller 53 controls the electromagnetic force generated by the coil portion 10 to be increased in stages on the basis of the tolerance range of the spring constant of the spring 31. In the first stage, the controller 53 controls the electromagnetic force generated by the coil portion 10 to be a first electromagnetic force continuously for the first time. Specifically, the controller 53 outputs a PWM signal with a duty ratio corresponding to the first electromagnetic force to the generator 51 continuously for the first time. The first electromagnetic force may be set to be equal to or greater than the elastic force applied by the spring 31L when the moving contact 33L is present at the contact position, and to be smaller than the elastic force applied by the spring 31M when the moving contact 33M is present at the contact position. For example, the first electromagnetic force is set to be equal to or greater than the calculated elastic force F1 by substituting the lower limit value in the tolerance range for the spring constant k and substituting 0 for the distance x, in the above equation (1). Further, the first electromagnetic force may be set to be smaller than the calculated elastic force F1 by substituting a predetermined value in the tolerance range for the spring constant and substituting 0 for the distance x, in the above equation (1). Further, the first time may be equal to or longer than the time required for the moving contact 33L to which the elastic force of the spring 31L is applied to reach the fixed contact 21 after it starts moving toward the fixed contact 21. The first time may be determined experimentally. It is to be noted that the first time may be longer than a second time and a third time described later, because it takes time for the coil portion 10 to generate an electromagnetic force after it is energized. With this configuration, in the first stage, the moving contact 33L may reach the fixed contact 21.

In the example illustrated in FIG. 2, at the time t1, the controller 53 may acquire an on signal from the control device 4. At the time t1, the controller 53 starts control of the first stage. The controller 53 controls, continuously for the first time from the time t1, the electromagnetic force of the coil portion 10 to be the first electromagnetic force. For example, the controller 53 sets the duty ratio of the PWM signal to 80% continuously for the first time T1. In the example illustrated in FIG. 2, the duty ratio of 80% is the duty ratio corresponding to the first electromagnetic force. When the duty ratio of the PWM signal increases to 80%, the coil current increases and the electromagnetic force of the coil portion 10 will be the first electromagnetic force. When the electromagnetic force of the coil portion 10 will be the first electromagnetic force, as illustrated in FIG. 3, the speed of the moving contact 33L increases relatively slowly after the time t1. That is, the moving contact 33L accelerates. After that, as the moving contact 33L displaces toward the approaching direction A, the elastic force of the spring 31L increases. As a result, acceleration of the moving contact 33L decreases. Further, as illustrated in FIG. 3, at the time t11, the displacement of the moving contact 33L is 0. That is, at the time t11, the moving contact 33L may hit the fixed contact 21 at a relatively low speed. In this manner, when the moving contact 33L hits the fixed contact 21 at a low speed at the time t11, the impact generated by the moving contact 33L hitting the fixed contact 21 may be weakened. When the impact generated by the moving contact 33L hitting the fixed contact 21 is weakened, noise generation may be prevented. After the time t11, the moving contact 33L is in contact with the fixed contact 21. Thus, after the time t11, the speed of the moving contact 33L will be 0. It is to be noted that, when the elastic force applied by the spring 31L is balanced with the first electromagnetic force when the moving contact 33L is present at the contact position, the impact caused by the moving contact 33L hitting the fixed contact 21 will decrease further.

It is to be noted that, at the time t11 illustrated in FIG. 3, both the moving contacts 33M and 33U are present at the fully open position P. However, when the moving contacts 33M and 33U are present at the fully open position P, if the first electromagnetic force is greater than the elastic force applied by the springs 31M and 31U, the moving contacts 33M and 33U may separate from the fully open position P. In this case, in the first time, the moving contacts 33M and 33U separate from the fully open position P and may be present at a position not reaching the contact position.

In the next stage following the first stage, the controller 53 controls the electromagnetic force generated by the coil portion 10 to be a second electromagnetic force that is larger than the first electromagnetic force, continuously for the second time. Specifically, the controller 53 outputs a PWM signal with a duty ratio corresponding to the second electromagnetic force to the generator 51, continuously for the second time. The second electromagnetic force may be set to be equal to or greater than the elastic force applied by the spring 31M when the moving contact 33M is present at the contact position, and may be set to be smaller than the elastic force applied by the spring 31U when the moving contact 33U is present at the contact position. For example, the second electromagnetic force is set to be equal to or greater than the calculated elastic force F1 by substituting a predetermined value in the tolerance range for the spring constant k and substituting 0 for the distance x, in the above equation (1). Further, the second electromagnetic force is set to be smaller than the calculated elastic force F1 by substituting the upper limit value in the tolerance range for the spring constant k and substituting 0 for the distance x, in the above equation (1). Further, the second time may be equal to or greater than the time required for the moving contact 33M to which the elastic force of the spring 31M having a spring constant of a predetermined value is applied to reach the fixed contact 21 after start of the second time, for example. The second time may be determined experimentally. With this configuration, in the next stage, the moving contact 33M may reach the fixed contact 21.

In the example illustrated in FIG. 2, the time t2 is the time at which the first stage has finished. The controller 53 controls the electromagnetic force of the coil portion 10 to be the second electromagnetic force that is larger than the first electromagnetic force, continuously for the second time T2 from the time t2. For example, the controller 53 controls the duty ratio of the PWM signal to be 85%, continuously for the second time T2. In the example illustrated in FIG. 2, 85% of the duty ratio is the duty ratio corresponding to the second electromagnetic force. When the duty ratio of the PWM signal increases to 85%, the coil current increases and the electromagnetic force of the coil portion 10 will be the second electromagnetic force. When the electromagnetic force of the coil portion 10 will be the second electromagnetic force, as illustrated in FIG. 3, after the time t2, the speed of the moving contact 33M increases relatively slowly. That is, the moving contact 33M accelerates. After that, as the moving contact 33M displaces toward the approaching direction, the elastic force of the spring 31M increases. Thus, the acceleration of the moving contact 33M decreases. Further, at the time t21, the displacement of the moving contact 33M will be 0. That is, at the time t21, the moving contact 33M may hit the fixed contact 21 at a relatively low speed. When the moving contact 33M hits the fixed contact 21 at a low speed at the time t21, an impact caused by the moving contact 33M hitting the fixed contact 21 may be weakened. When the impact caused by the moving contact 33M hitting the fixed contact 21 is weakened, noise generation may be prevented. It is to be noted that, after the time t21, the moving contact 33M is in contact with the fixed contact 21. Thus, after the time t21, the speed of the moving contact 33M is 0. It is to be noted that, when the moving contact 33M is present at the contact position, if the elastic force applied by the spring 31M is balanced with the first electromagnetic force, the impact caused by the moving contact 33M hitting the fixed contact 21 decreases further.

It is to be noted that, at the time t21 illustrated in FIG. 3, the moving contact 33U is present at the fully open position P. However, if the second electromagnetic force is greater than the elastic force applied by the spring 31U when the moving contact 33U is present at the fully open position P, the moving contact 33U may separate from the fully open position P. In this case, in the second time, the moving contact 33U may be present at the position separating from the fully open position P and not reaching the contact position.

In the final stage after the second time, the controller 53 controls the electromagnetic force generated by the coil portion 10 to be the third electromagnetic force, which is larger than the first electromagnetic force and the second electromagnetic force, continuously for the third time. Specifically, the controller 53 outputs a PWM signal with the duty ratio corresponding to the third electromagnetic force to the generator 51, continuously for the third time. The third electromagnetic force may be set to be equal to or greater than the elastic force applied by the spring 31U when the moving contact 33U is present at the contact position. For example, the third electromagnetic force is set to be equal to or greater than the calculated elastic force F1 by substituting the upper limit value in the tolerance range for the spring constant k and substituting 0 for the distance x, in the above equation (1). Further, the third time may be equal to or longer than the time required for the moving contact 33U to which the elastic force of the spring 31U having a spring constant of the upper limit value in the tolerance range is applied to reach the fixed contact 21 after start of the third time, for example. The third time may be determined experimentally. With this configuration, in the final stage, the moving contact 33U may reach the fixed contact 21.

In the example illustrated in FIG. 2, at the time t3, the controller 53 starts control of the final stage. The controller 53 controls the electromagnetic force of the coil portion 10 to be the third electromagnetic force for the third time T3 continuously from the time t3. For example, the controller 53 controls the duty ratio of the PWM signal to be 90% for the third time T3 continuously. In the example illustrated in FIG. 2, 90% of the duty ratio is the duty ratio corresponding to the third electromagnetic force. When the duty ratio of the PWM signal increases to 90%, a coil current increases and the electromagnetic force of the coil portion 10 will be the third electromagnetic force. When the electromagnetic force of the coil portion 10 will be the third electromagnetic force, as illustrated in FIG. 3, after the time t3, the speed of the moving contact 33U may increase relatively slowly. That is, the moving contact 33U accelerates. After that, as the moving contact 33U displaces toward the approaching direction, the elastic force of the spring 31U increases. Thus, acceleration of the moving contact 33U decreases. Further, at the time t31, the displacement of the moving contact 33U may be 0. That is, at the time t31, the moving contact 33U may hit the fixed contact 21 at a relatively low speed. At the time 31, the moving contact 33U hits the fixed contact 21 at a low speed, and as a result, the impact caused by the moving contact 33U hitting the fixed contact 21 may be weakened. When the impact caused by the moving contact 33U hitting the fixed contact 21 is weakened, noise generation may be prevented. It is to be noted that, if the elastic force applied by the spring 31U is balanced with the first electromagnetic force when the moving contact 33U is present at the contact position, the impact generated when the moving contact 33U hits the fixed contact 21 is further reduced.

With this configuration, even if the spring 31 has any spring constant in the tolerance range, the moving contact 33 of the spring 31 may reach the fixed contact 21 by the time t4 illustrated in FIG. 2. Further, the electromagnetic force of the coil portion 10 increases in stages, and as a result, even if the spring 31 has any spring constant in the tolerance range, the impact caused by the moving contact 33 hitting the fixed contact 21 is weakened, and noise generation may be prevented.

It is to be noted that the time required to switch the fixed contact 21 and the moving contact 33 in the non-contact state to the contact state may be almost the same as the operating time, specified in the relay device 1, for electrically connecting a device connected to the relay device 1. For example, the time Tt from the time t1 to the time t6 illustrated in FIG. 2 may almost be the same as the operating time for electrically connecting the storage battery 2 and the load apparatus 3 illustrated in FIG. 1, specified in the relay device 1. In this case, the first time, the second time and the third time may be adjusted as appropriate on the basis of the specified operating time. Further, an electromagnetic force may be increased in more stages by providing a period of time during which an electromagnetic force that is larger than the first electromagnetic force and smaller than the second electromagnetic force is generated between the first time and the second time. That is, between the first time and the third time, an electromagnetic force may be increased in stages as appropriate, not limiting to providing the second time.

When switching the fixed contact 21 and the moving contact 33 to the contact state, the controller 53 keeps the switching element of the generator 51 in the on state by keeping the duty ratio of the PWM signal to 100%. The controller 53 keeps the fixed contact 21 and the moving contact 33 in the contact state by keeping the switching element of the generator 51 in the on state.

### Operation Example of Relay Device

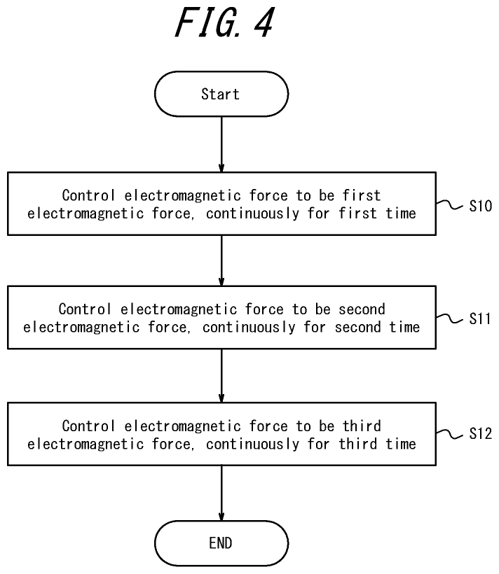

FIG. 4 is a flowchart illustrating operation of the relay device 1 illustrated in FIG. 1. When acquiring an on signal from the control device 4, the controller 53 may start the process illustrated in FIG. 4.

The controller 53 controls the electromagnetic force generated by the coil portion 10 to be the first electromagnetic force, continuously for the first time (step S10).

The controller 53 controls the electromagnetic force generated by the coil portion 10 to be the second electromagnetic force, continuously for the second time (step S11).

The controller 53 controls the electromagnetic force generated by the coil portion 10 to be the third electromagnetic force, continuously for the third time (step S12).

Here, as a comparative example, assuming that the electromagnetic force of the coil portion is controlled to be continuously increased in proportion to the time. In this comparative example, when the spring constant varies in the tolerance range, the acceleration of the moving contact cannot be reduced effectively as the electromagnetic force continuously increases. As a result, in the comparative example, the moving contact continues to accelerate and hits the fixed contact, and noise may occur.

On the other hand, in the relay device 1 according to this embodiment, when the fixed contact 21 and the moving contact 33 in the non-contact state are switched to the contact state, the electromagnetic force of the coil portion 10 is controlled to be increased in stages on the basis of the tolerance range of the spring constant of the spring 31. With this configuration, even if the spring 31 has any spring constant in the tolerance range, the moving contact 33 separates from the stopper 40, and then may hit the fixed contact 21 in a state being decelerated by the elastic force of the spring 31. Thus, in the relay device 1 according to this embodiment, noise generation may be prevented.

Furthermore, in the relay device 1 according to this embodiment, the electromagnetic force of the coil portion 10 is increased in stages, not continuously. Here, when the electromagnetic force of the coil portion 10 is increased continuously, the moving contact 33 may vibrate. When the moving contact 33 vibrates, chattering may occur. In this embodiment, the electromagnetic force of the coil portion 10 is increased in stages, and as a result, chattering generation due to vibration of the moving contact 33 may be prevented. In this embodiment, chattering generation is prevented, and as a result the durability of the relay device 1 can be improved.

Although an embodiment of this disclosure has been described on the basis of the drawings and the examples, it is to be noted that various changes and modifications may be made easily by those who are ordinarily skilled in the art on the basis of this disclosure. Accordingly, it is to be noted that such changes and modifications are included in the scope of this disclosure. For example, functions and the like included in each function part can be rearranged without logical inconsistency, and a plurality of function parts can be combined into one or divided.

For example, in this embodiment, as a control to increase the electromagnetic force of the coil portion 10 in stages, it has been described that the electromagnetic force of the coil portion 10 is increased in three stages including the first electromagnetic force, the second electromagnetic force and the third electromagnetic force, although not limited thereto. The electromagnetic force of the coil portion 10 may be controlled to be increased in stages on the basis of the tolerance range of the spring constant of the spring 31. Further, before the first time, a step may be provided in which an electromagnetic force (with a duty ratio of 75%, for example) that is equal to or greater than the elastic force applied by the spring 31L is applied when the moving contact 33L is present at the fully open position P and an electromagnetic force that is smaller than the elastic force applied by the spring 31L is applied for a predetermined time. As a result, by this step, the moving contact 33L separates from the stopper 40 and is held between the stopper 40 and the fixed contact 21. After that, at the first time, the moving contact 33L reaches the contact position. The predetermined time in this case may be longer than the first time, the second time and the third time or the same as them.

### REFERENCE SIGNS LIST

1 Relay device

2 Storage battery

3 Load apparatus

4 Control device

10 Coil portion

11 Coil

20 Terminal board

21 Fixed contact

30 Terminal board

31, 31L, 31M, 31U Spring

32 Moving piece

33, 33L, 33M, 33U Moving contact

40 Stopper

50 Drive circuit

51 Generator

52 Memory

53 Controller

1. A relay device, comprising:
a fixed contact;
a moving contact;
a spring configured to apply an elastic force in a separating direction in which the moving contact separates from the fixed contact;
a coil portion configured to generate an electromagnetic force that moves the moving contact toward the fixed contact through energization; and a drive circuit configured to control the electromagnetic force by controlling coil current flowing through the coil portion, wherein,
the drive circuit controls, when switching the fixed contact and the moving contact in a non-contact state to a contact state, the electromagnetic force to be a first electromagnetic force, continuously for a first time, after that, controls the electromagnetic force to be increased in stages from the first electromagnetic force, and in a final stage in which the electromagnetic force is controlled to be increased from the first electromagnetic force in stages, controls the electromagnetic force to be a predetermined electromagnetic force that is larger than the first electromagnetic force,
the first electromagnetic force being equal to or greater than an elastic force applied by the spring having a spring constant of a lower limit value in a tolerance range when the moving contact is present at a contact position in contact with the fixed contact, and being smaller than the elastic force applied by the spring having a spring constant of a median value in the tolerance range when the moving contact is present at the contact position, and
the predetermined electromagnetic force being equal to or greater than the elastic force applied by the spring having a spring constant of an upper limit value in the tolerance range when the moving contact is present at the contact position.

2. The relay device according to claim 1, wherein the first time is equal to or longer than time required for the moving contact to which an elastic force of the spring having a spring constant of a lower limit value in the tolerance range is applied to reach the fixed contact.

3. The relay device according to claim 1, wherein the drive circuit controls, in a next stage following a first stage in which the electromagnetic force is controlled to be increased in stages, the electromagnetic force to be a second electromagnetic force that is larger than the first electromagnetic force, continuously for a second time.

4. The relay device according to claim 3, wherein the second electromagnetic force is equal to or greater than the elastic force applied by the spring having a constant value of the median value when the moving contact is present at the contact position, and is smaller than the elastic force applied by the spring having a spring constant of an upper limit value in the tolerance range when the moving contact is present at the contact position.

5. The relay device according to claim 4, wherein the second time is equal to or longer than time required for the moving contact to which the elastic force applied by the spring having a spring constant of the median value is applied to reach the fixed contact.

6. The relay device according to claim 3, wherein the first time is longer than the second time.

7. The relay device according to claim 3, wherein the drive circuit controls the electromagnetic force to be the predetermined electromagnetic force, continuously for a third time, after an elapse of the second time.

8. The relay device according to claim 7, wherein the third time is equal to or longer than time required for the moving contact to which an elastic force of the spring having a spring constant of an upper limit value of the tolerance range is applied to reach the fixed contact.

9. The relay device according to claim 7, wherein the first time is longer than the third time.

10. The relay device according to claim 1, wherein the drive circuit generates the coil current on the basis of Pulse Width Modulation (PWM) control.

11. A control method of a relay device, the relay device comprising:
a fixed contact;
a moving contact;
a spring configured to apply an elastic force in a separating direction in which the moving contact separates from the fixed contact;
a coil portion configured to generate an electromagnetic force that moves the moving contact toward the fixed contact through energization; and a drive circuit configured to control the electromagnetic force by controlling coil current flowing through the coil portion,
the method comprising the steps of:
controlling, by the drive circuit, the electromagnetic force to be a first electromagnetic force, continuously for a first time, when switching the fixed contact and the moving contact in a non-contact state to a contact state; controlling, by the drive circuit, the electromagnetic force to be increased in stages from the first electromagnetic force; and
controlling, by the drive circuit, the electromagnetic force to be a predetermined electromagnetic force that is larger than the first electromagnetic force, in a final stage in which the electromagnetic force is controlled to be increased in stages from the first electromagnetic force, wherein:
the first electromagnetic force is equal to or greater than an elastic force applied by the spring having a spring constant of a lower limit value in a tolerance range when the moving contact is present at a contact position in contact with the fixed contact, and is equal to or smaller than the elastic force applied by the spring having a spring constant of a median value in the tolerance range when the moving contact is present at the contact position; and
the predetermined electromagnetic force is equal to or greater than the elastic force applied by the spring having a spring constant of an upper limit value in the tolerance range when the moving contact is present at the contact position.
